(19) United States
(12) Patent Application Publication
(10) Pub. No.: US 2019/0333176 A1
(43) Pub. Date: Oct. 31, 2019

(54) RECORDING RECOMMENDATION METHOD, DEVICE, APPARATUS AND COMPUTER-READABLE STORAGE MEDIUM

(71) Applicant: Ping An Technology (Shenzhen) Co., Ltd., Shenzhen, Guangdong (CN)

(72) Inventor: Chao Hu, Shenzhen, Guangdong (CN)

(73) Assignees: Ping An Technology (Shenzhen) Co., Ltd., Shenzhen, Guangdong (CN); Ping An Technology (Shenzhen) Co., Ltd., Shenzhen, Guangdong (CN)

(21) Appl. No.: 16/097,835

(22) PCT Filed: Feb. 2, 2018
(86) PCT No.: PCT/CN2018/075053

§ 371 Date: Oct. 31, 2018

(30) Foreign Application Priority Data
Dec. 28, 2017 (CN) 201711460485.2

(51) Int. Cl. G06Q 50/20; G06Q 10/10; G06F 16/68; G06F 16/635; G06F 16/638

(52) U.S. Cl. CPC G06Q 50/205; G06Q 10/10; H04M 2203/403; G06F 16/635; G06F 16/638; G06F 16/68

(57) ABSTRACT

Disclosed are a recording recommendation method, device, apparatus and computer-readable storage medium. The method includes: determining whether a current user is a new user, if an instruction of the current user to view sales call recordings is received; selecting corresponding call records from sales call recording records as call records to be recommended according to a first preset rule, if the current user is a new user, wherein, the call record includes a call recording; acquiring call records satisfying a preset condition from the sales call recording records, if the current user is not a new user; selecting corresponding call records from the call records satisfying the preset condition as call records to be recommended according to a second preset rule; displaying the call records to be recommended to the current user.

The present application claims priority to Chinese patent application No. 201711460485.2, filed with the Chinese Patent Office on Dec. 28, 2017 and entitled “recording recommendation method, device, apparatus and computer-readable storage medium”, the contents of which are incorporated herein by reference in its entirety.

### FIELD OF INVENTION

The present disclosure relates to the technical field of information processing, and more particularly, to a recording recommendation method, device, apparatus and computer-readable storage medium.

### BACKGROUND OF INVENTION

Sales agents of the telemarketing generate millions of call records every day, and a call record includes a call recording, and the call recording is a reflection of an agent's sales experience. On the other hand, the sharing of agent experience in a team and the training for newcomer need practical experience for reference. Therefore, a call recording sharing platform can be set up, to share the call recording corresponding to the call record generated by the agent of the telemarketing to the users of the platform for them to study. If the call recordings corresponding to the call records generated every day are indiscriminately recommended to the users in the platform, viewing the valueless call recordings in the numerous call recordings will be a waste of time and cannot play a role as a reference of experience. Besides, since the users of the platform are different, the products sold are not the same, and the sales experience is different, many users cannot get the call recordings that they are really interested in, resulting in a bad user experience.

### SUMMARY OF THE INVENTION

The embodiments of the present disclosure provide a recording recommendation method, device, apparatus and computer-readable storage medium, which could recommend different call recordings for different users, improving the accuracy of the recording recommendation, and improving the user experience.

In a first aspect, the embodiments of the present disclosure provide a recording recommendation method, including: determining whether a current user is a new user, if an instruction of the current user to view sales call recordings is received; selecting corresponding call records from sales call recording records as call records to be recommended according to a first preset rule, if the current user is a new user, wherein, the call record includes a call recording; acquiring call records satisfying a preset condition from the sales call recording records, if the current user is not a new user; selecting corresponding call records from the call records satisfying the preset condition as call records to be recommended according to a second preset rule; displaying the call records to be recommended to the current user.

In a second aspect, the embodiments of the present disclosure provide a recording recommendation device, and the device includes units for performing the recording recommendation method described in the above first aspect.

In a third aspect, the embodiments of the present disclosure further provide a computer apparatus, and the computer apparatus includes a memory, and a processor connected to the memory; the memory is used for storing computer program for implementing recording recommendation; the processor is used for running the computer program stored in the memory, to perform the recording recommendation method described in the above first aspect.

In a fourth aspect, the embodiments of the present disclosure provide a computer-readable storage medium, and the computer-readable storage medium stores computer program, and the computer program includes program instructions, and when the program instructions are executed by a processor, the program instructions implement the recording recommendation method described in the above first aspect.

The embodiments of the present disclosure, determining whether a current user is a new user, if an instruction of the current user to view sales call recordings is received; selecting corresponding call records from sales call recording records as call records to be recommended according to a first preset rule, if the current user is a new user, wherein, the call record includes a call recording; acquiring call records satisfying a preset condition from the sales call recording records, if the current user is not a new user; selecting corresponding call records from the call records satisfying the preset condition as call records to be recommended according to a second preset rule; displaying the call records to be recommended to the current user. The embodiments of the present disclosure could recommend different call recordings for different users, improving the accuracy of the recording recommendation, and improving the user experience.

### BRIEF DESCRIPTION OF THE DRAWINGS

FIG. 1 is a flow chart of a recording recommendation method provided by an embodiment of the present disclosure;

FIG. 2 is a sub-flow chart of a recording recommendation method provided by an embodiment of the present disclosure;

FIG. 3 is a sub-flow chart of a recording recommendation method provided by another embodiment of the present disclosure;

FIG. 4 is a sub-flow chart of a recording recommendation method provided by another embodiment of the present disclosure;

FIG. 5 is a schematic block diagram of a recording recommendation device provided by an embodiment of the present disclosure;

FIG. 6 is a schematic block diagram of a first selecting unit provided by an embodiment of the present disclosure;

FIG. 7 is a schematic block diagram of a second selecting unit provided by an embodiment of the present disclosure;

FIG. 8 is a schematic block diagram of a second selecting unit provided by another embodiment of the present disclosure;

FIG. 9 is a schematic block diagram of a computer apparatus provided by an embodiment of the present disclosure.

### DESCRIPTION OF THE EMBODIMENTS

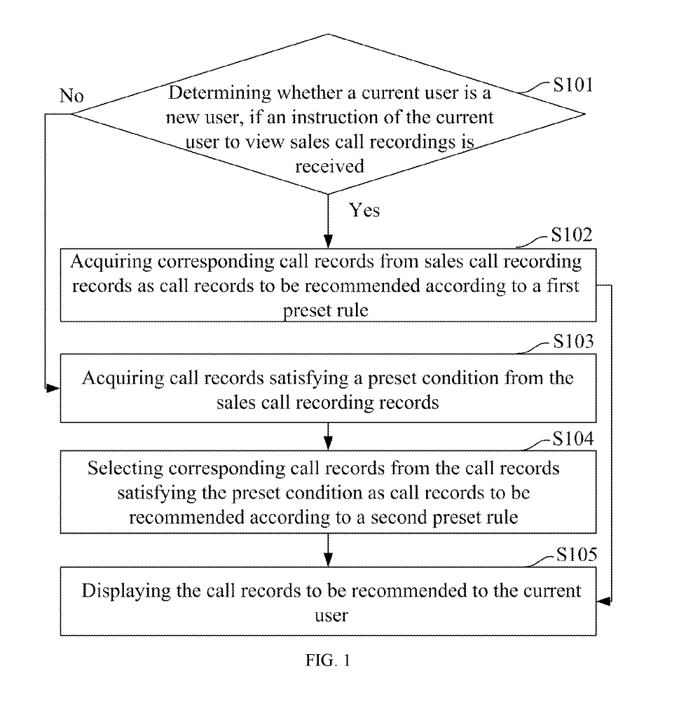

FIG. 1 is a flow chart of a recording recommendation method provided by an embodiment of the present disclosure. The method includes S101-S105.

S101, determining whether a current user is a new user, if an instruction of the current user to view sales call recordings is received.

In the call recording sharing platform, when the user opens the recording recommendation page or clicks the button of viewing the recording recommendation, it is regarded as receiving an instruction to view the sales call recordings. When receiving the instruction of the current user to view the sales call recordings, determine whether the current user is a new user. Wherein, the new user includes the user who logs into the call recording sharing platform for the first time, which could also be understood as including the user who has used the recording sharing platform but has not logged into. If the current user has used the platform but has not logged into, the system will assign a random number and identify the user by the random number. If a corresponding identifier of the current user is not retrieved in the database of the platform, or if an identifier of the current user detected is a random number, determine the current user is a new user; otherwise, determine the current user is not a new user. Wherein, the identifier corresponding to the current user includes a user name and a password or a mobile phone number or a two-dimensional code that can identify the user. In other embodiments, the new user may also include the user who logs in within a period of time after the first login starts. For example, the user who logs in within 7 days after the first login starts is a new user.

S102, acquiring corresponding call records from sales call recording records as call records to be recommended according to a first preset rule, if the current user is a new user.

The sales call recording record saves all situations about sales recordings, including the situation related to the call and the sales situation about the sales business. Specifically, the sales call recording record may include a plurality of tables, including a call table, a sales table, a sales call table, and the like. From the sales call recording record, one could know what kind of product is sold, the sales team (seller) who sells the product, whether the final sale is a success, the sales amount, the total number of times of calls, the sequence number of a call, the call duration of each call, the time of a call, the specific call recording, etc. The sales call recording record also includes a recommended call table, and a call record of the recommended call table saves the score, comment, number of likes, and number of shares of the corresponding call recording, and the like. The call record includes a product, a sales team (seller), a sales amount, time of call, a call duration, and specific call recordings, etc. Acquiring corresponding call records from sales call recording records refers to acquiring corresponding call records from the multiple tables of the sales call recording records. Acquiring corresponding call records from sales call recording records according to a first preset rule as call records to be recommended, including: according to the order of the scores of the call recordings from high to low, or according to the order of the numbers of comments of the call recordings from high to low, or according to the order of the numbers of likes of the call recordings from high to low, or according to the order of the numbers of shares of the call recordings from high to low, acquiring a preset number of call records as the call records to be recommended. Other embodiments may use the combination of the multiple. Wherein, the preset number may be 10 or other number. The preset number could be set according to the user's setting, for example, receive a specific number input in the input box by the user, and set the number as the preset number; the preset number may also be set to be a fixed number. It can be understood that, for a new user, the call recordings of all the call records on the call recording sharing platform are not viewed by the user, and all are new recordings, so the recommendation is performed according to the quality of the recordings when recommending the recordings to a new user, so that the new user could view the call recordings of high quality. It should be noted that, if a new user logs into the platform, and the call recordings in the sales call recording records have not been scored and have not been praised and have not been liked and have not been shared, randomly recommend the preset number of call records from the call records of the recommended call table, or recommend the call records according to the way of steps S103-S104.

S103, acquiring call records satisfying a preset condition from the sales call recording records, if the current user is not a new user, wherein, the preset condition includes: time of a call is within a preset time period, and a call duration is within a preset duration, and a total number of times of calls is within a preset total number of times, and a sales amount reaches a preset sales amount, and be the first call in the call. Wherein, the time of the call refers to the local time at which the call starts, and the preset time period refers to a time period in which the current time is the end point. The time of the call is within a preset time period, which could be understood that, the time of the call is recent, such as within one week, so as to update the recommended call recording in time, so that the user could see the new call recording. On the other hand, the user doesn't want to see the same recommended call recordings every time, because these recordings may have been seen by the user. Since generally for an agent of the telemarketing, during the process of the successful sale of a product, the agent may usually generate multiple call records. For example, according to the sequence number of the time of calls, the call records could be named as a first call record, a second call record, a third call record, and the like. Among them, the first call is the most difficult, and has a great influence on the success of the final sale, so choose to recommend the call recording corresponding to the first call record. For example, the preset duration could be: 30-60 minutes, and the preset total number of times could be 3 times, and the preset sales amount could be the highest sales amount corresponding to the product multiplied by a weight, wherein the weight could be 0.8. Specifically, if the current user is not a new user, acquire the first call records of the calls from the sales call recording records, and the call satisfies that: the time of the call is within one week, the call duration is within 30-60 minutes, the total number of times of calls is within three times, and the sales amount reaches the preset sales amount.

S104, selecting corresponding call records from the call records satisfying the preset condition as call records to be recommended according to a second preset rule.

According to a user's authority to select the call records matching the user's authority from the call records satisfying the preset condition as the call records to be recommended, or according to a user's individual characteristic to select the corresponding call records from the call records satisfying the preset condition as the call records to be recommended. Or according to other manners to acquire the corresponding call records as the call records to be recommended. It should be noted that, the number of fields corresponding to each record in the call records to be recommended may be less than the number of fields in the call record satisfying the preset condition, or may be the same. For example, the fields corresponding to each record in the call records to be recommended include: product, recommendation team (recommendation person), sales amount, call duration, specific call recording, etc.; the fields in the call record satisfying the preset condition include: product, recommendation team (recommendation person), sales amount, time of the call, call duration, specific call recording, etc.

S105, displaying the call records to be recommended to the current user.

Wherein, according to a preset format to display the call record to be recommended to the current user. The preset format includes according to different products to display corresponding call record, and also includes the number of call records displayed in each product, and each call record is by the same description rule and/or naming rule. For example, the description rule and/or the naming rule may be: product+recommendation team (recommendation person)+sales amount+call duration+specific call recording. By the description rule and/or the naming rule, it is convenient for the current user to easily and quickly understand the call recording, so as to determine whether to view the call recording. Click on the call recording corresponding to the call log to view the specific call recording. The preset format may also be other formats, which are not limited herein.

The above embodiment could recommend different call recordings for different users, improving the accuracy of the recording recommendation, and improving the user experience.

FIG. 2 is a sub-flow chart of a recording recommendation method provided by an embodiment of the present disclosure. As shown in FIG. 2, selecting corresponding call records from the sales call recording records as call records to be recommended according to a first preset rule, that is, the step S102 includes S201-S203.

S201, acquiring scores, comments, numbers of likes, and numbers of shares of call recordings corresponding to recommended call records from the sales call recording records.

It can be understood that, after each user views a specific call recording, the user could evaluate the call recording, such as grading, discussing, giving like and sharing, and each user may use one of the ways to evaluate the viewed call recording, or may use a variety of ways to evaluate, and of course the user could make no evaluation. For example, the sales call recording record saves the recommended call table, and the call table saves relevant call recording information, and the relevant call recording information includes the recording score, the comment content, the number of likes and the number of shares and the like. Specifically, each user's grading to the recording may be a star rating, for example, a total score is 10 points, and a star represents one point. The discussing is entering the evaluation of the user after listening to the recording in the input box, such as calling the rich text editing plug-in of ckeditor to edit the evaluation. There are many channels to share when sharing recordings, including mainstream social tools, such as WeChat and Microblog and the like, and when sharing, the user could share to groups, or to individuals, such as the known friends on the call recording sharing platform, or share to the current user's personal social page. It should be noted that, the number of likes here also includes the number of boos. For example, the thumb-up mark represents the like, and the thumb-down mark represents the boo.

S202, calculating recommendation scores of the call recordings according to a preset formula, wherein, the preset formula is: M=λ₁A+λ₂B+λ₃C+λ₄D.

Wherein, M is the recommendation score, and λ₁, λ₂, λ₃, and λ₄ are weight coefficients, and λ₁+λ₂+λ₃+λ₄=1, and A represents a score normalization value, B represents a favorable rate, C represents a like rate, and D represents a normalization value of the number of shares. Wherein, λ₁, λ₂, λ₃, and λ₄ are determined according to degree of importance of corresponding items to the recommendation score. Score normalization value=acquired recording score/total score of recording. If the acquired recording score is 8, and the total score of recording is 10, then the score normalization value is 0.8. Favorable rate=number of favorable comments/total number of comments. Specifically, for example, extract keywords of each comment in the comment, if a keyword of the extracted keywords is a preset keyword, such as an emotional word of the user to the recording object, such as “great”, or “very good”, etc., determine the comment is a favorable comment. Count the number of favorable comments of the recording object, and calculate the favorable rate according to favorable rate=number of favorable comments/total number of comments. Like rate=number of likes/(number of likes+number of boos). Normalization value of the number of shares=number of shares/maximum number of shares. Wherein, the maximum number of shares is the maximum number in the numbers of shares of the call recordings of the product corresponding to the call recording object. For example, for a call recording of the product A, the number of shares is 20, and the maximum number of shares in the call recordings corresponding to the product A is 50, then the normalization value of the number of shares is 0.4. For a call recording, if a value of a corresponding item is default, then the default is regarded as zero. For example, there is no sharing in the call recording, and then the corresponding normalization value of the number of shares will be zero.

S203, acquiring a preset number of call records from the recommended call records as the call records to be recommended according to an order of the recommendation scores from high to low. Wherein, the call record includes a call recording.

The embodiment further defines how to acquire the call recordings to be recommended for a new user.

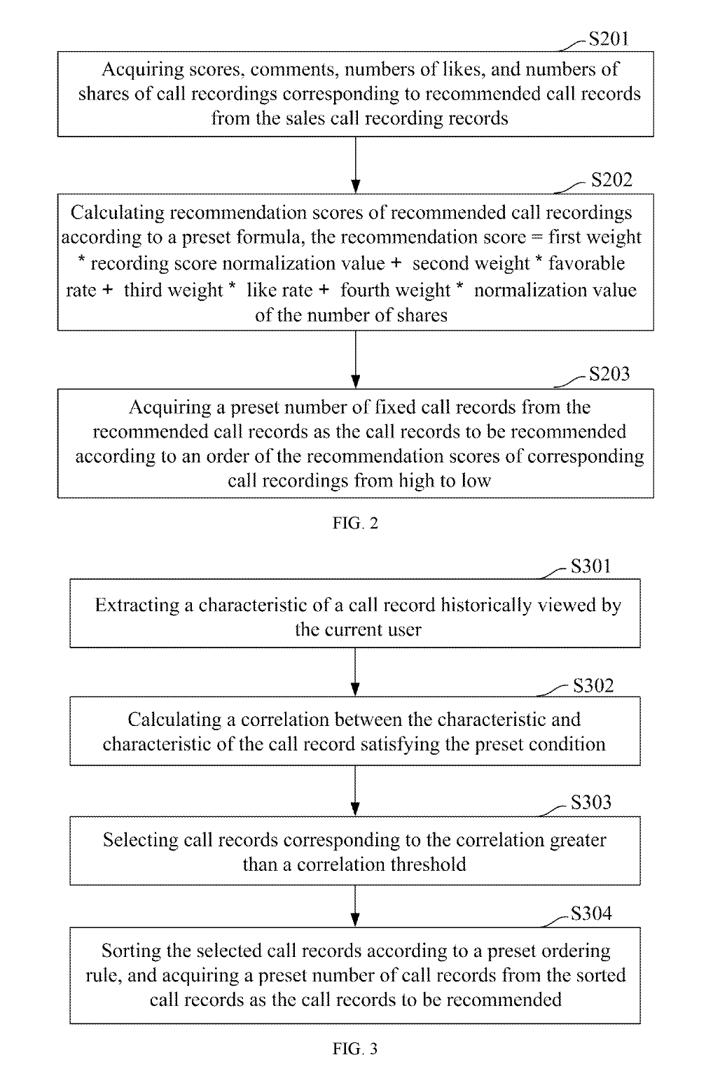

FIG. 3 is a sub-flow chart of a recording recommendation method provided by another embodiment of the present disclosure. As shown in FIG. 3, selecting corresponding call records from the call recordings satisfying a preset condition as call records to be recommended according to a second preset rule, that is, the step S104 includes S301-S304.

S301, extracting a characteristic of a call record historically viewed by the current user.

Acquire the call records historically viewed by the current user, and acquire the characteristics of the call records, for example, the characteristic includes sales amount, call duration, recommendation team, and so on.

S302, calculating a correlation between the characteristic and characteristic of the call record satisfying the preset condition.

The correlation could also be understood as a similarity, and the similarity could be calculated by cosine similarity and the like. Cosine similarity is a similarity evaluated by calculating the cosine of the angle between two vectors. Specifically, quantify the characteristic such as sales amount, call duration, recommendation team, etc., for example, uniformly use seconds to express the call duration as a specific number; form the quantification data into a vector; and calculate the similarity value between the vectors according to the cosine similarity. The larger the similarity value obtained by calculation is, the higher the similarity between two vectors is, and the smaller the similarity value is, the smaller the similarity between the two vectors is.

S303, selecting call recordings corresponding to the correlation greater than a correlation threshold.

It could be understood that, the characteristic of the call recording satisfying the preset condition is very similar to that of the recording records historically viewed by the user, for example, the sales amount and the sales amount in the recording record historically viewed by the user are not much different, and the like.

S304, sorting the selected call records according to a preset ordering rule, and acquiring a preset number of call recordings from the sorted call records as the call recordings to be recommended.

The preset ordering rule includes: for different products, according to the order of the correlations from large to small, the order of the sales amount from high to low, the order of the time of call from lately to early, the order of the total numbers of times of calls from less to more. Wherein, it could be understood that, firstly sort according to the order of correlations from large to small, and for the same correlation, sort according to the order of the sales amount from high to low, and for the same sales amount, sort according to the order of the time of call from lately to early, and for the same time of call, sort according to the order of the total numbers of times of calls from less to more. Acquire the top ranked preset number of call records from the sorted call records as the call records to be recommended.

The embodiment further defines that, for an old user, acquiring call records to be recommended from the call records satisfying the preset condition according to the information of the recording records historically viewed by the current user, so as to recommend call recordings according to the individual demand of the current user, improve the accuracy of recording recommendation, and improve the user experience.

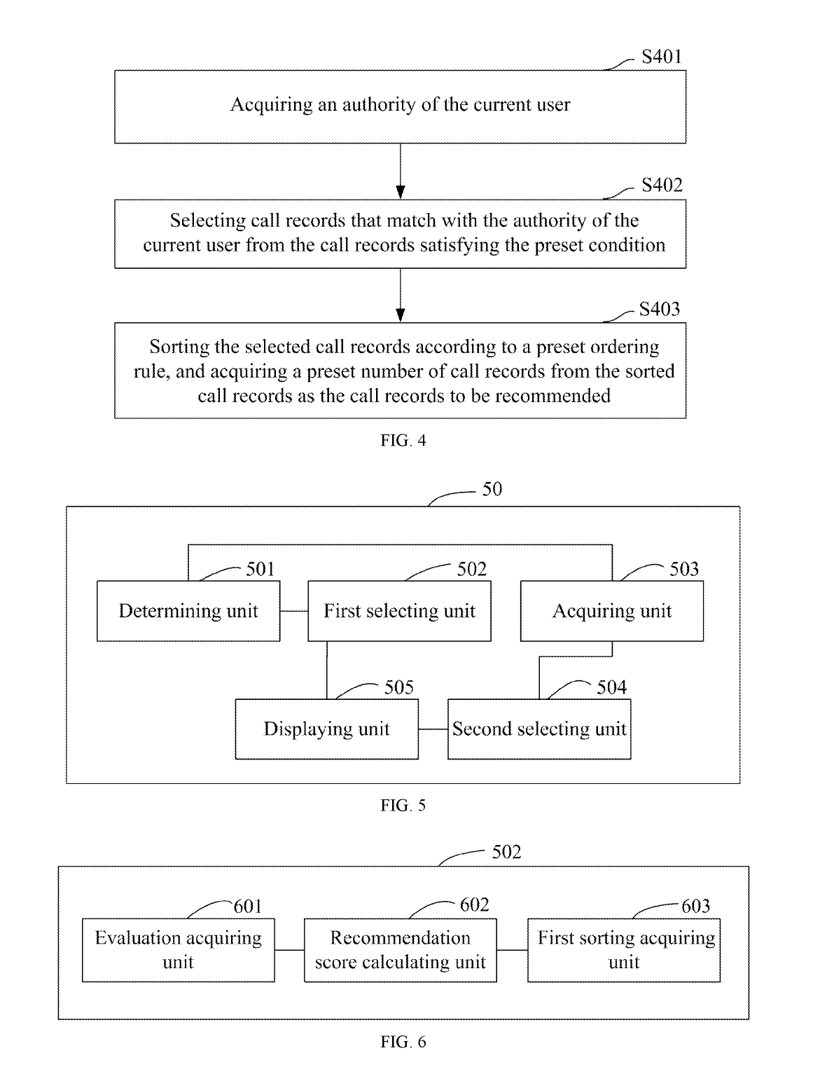

FIG. 4 is a sub-flow chart of a recording recommendation method provided by another embodiment of the present disclosure. As shown in FIG. 3, selecting corresponding call recordings from the call recordings satisfying a preset condition as call recordings to be recommended according to a second preset rule, that is, the step S104 includes S401-S403.

S401, acquiring an authority of the current user.

Wherein, the current user's authority includes the identity of the current user, the team to which the current user belongs, the product being sold, and the like, for example, the identity of the current user includes manager and ordinary employee, wherein, the managers are divided into different levels, and the authorities for viewing call recordings corresponding to different levels are different. The authorities corresponding to different management levels and ordinary employee could be preset. For example, for the manager, the relevant work experience is generally rich, and the call recording of the newcomer has little referential significance, therefore, it could be preset that, for such users, the call recordings of the newcomer are not matched with such users' demand.

S402, selecting call records that match with the authority of the current user from the call records satisfying the preset condition.

From the call records satisfying the preset condition, select the call records matching with the identity of the current user and of the team or related teams to which the current user belongs, or select the call records matching with the identity of the current user and having the same or similar product being sold, or select the call records matching with the identity of the current user and of the team or related teams to which the current user belongs and having the same or similar product being sold. It could be understood that, for the user, what the user most sincerely expects to see is the call recordings being successful in sales in the user's own team or related teams, and the call recordings being successful in sales and the product of which are the same as or similar to the product the user sells, because of the great referential significance to the user oneself.

S403, sorting the selected call records according to a preset ordering rule, and acquiring a preset number of call records from the sorted call records as the call records to be recommended.

The preset ordering rule may be: according to the order of the sales amount from high to low, the order of the time of call from lately to early, the order of the total numbers of times of calls from less to more. Wherein, it could be understood that, firstly sort according to the order of the sales amount from high to low, and for the same sales amount, sort according to the order of the time of call from lately to early, and for the same time of call, sort according to the order of the total numbers of times of calls from less to more. Acquire the top ranked preset number of call records from the sorted call records as the call records to be recommended.

The above embodiment further defines that, for an old user, acquiring call records to be recommended from the call records satisfying the preset condition according to the authority of the current user, what could be understood as recommending the call recordings matching with the identity of the current user and of the team or related teams to which the user belongs, and/or the call recordings having the same or similar products being sold, improving the accuracy of the recording recommendation, and improving the user experience.

In other embodiments, it could be understood that, when the call records to be recommended obtained by the user obtain are numerous, the user could further screen the call records that the user is interested according to the user's own demand. Specifically, acquire a screening instruction of the current user, and acquire call records related to the screening instruction of the current user to display from the displayed call records. For example, acquire the screening condition input in the input box by the user and/or selected, for example, the input and/or selected screening condition includes: a call record of which the duration of call is ranged from 45 minutes to one hour and the recommendation team is the team A.

FIG. 5 is a schematic block diagram of a recording recommendation device provided by an embodiment of the present disclosure. The device 50 includes a determining unit 501, a first selecting unit 502, an acquiring unit 503, a second selecting unit 504, and a displaying unit 505.

The determining unit 501 is for determining whether a current user is a new user if an instruction of the current user to view sales call recordings is received. The first selecting unit 502 is for acquiring corresponding call records from sales call recording records as call records to be recommended according to a first preset rule if the current user is a new user. The acquiring unit 503 is for acquiring call records satisfying a preset condition from the sales call recording records if the current user is not a new user, wherein, the preset condition includes: time of a call is within a preset time period, and a call duration is within a preset duration, and a total number of times of calls is within a preset total number of times, and a sales amount reaches a preset sales amount, and be the first call in the call. The second selecting unit 504 is for selecting corresponding call records from the call records satisfying the preset condition as call records to be recommended according to a second preset rule. The displaying unit 505 is for displaying the call records to be recommended to the current user.

FIG. 6 is a schematic block diagram of the first selecting unit 502 provided by an embodiment of the present disclosure. The first selecting unit is for selecting corresponding call records from sales call recording records as call records to be recommended according to a first preset rule, and the first selecting unit 502 includes an evaluation acquiring unit 601, a recommendation score calculating unit 602, and a first sorting acquiring unit 603.

The evaluation acquiring unit 601 is for acquiring scores, comments, numbers of likes, and numbers of shares of call recordings corresponding to recommended call records from the sales call recording records. The recommendation score calculating unit 602 is for calculating recommendation scores of the call recordings according to a preset formula, wherein, the preset formula is: M=λ₁A+λ₂B+λ₃C+λ₄D. Wherein, M is the recommendation score, and λ₁, λ₂, λ₃, and λ₄ are weight coefficients, and λ₁+λ₂+λ₃+λ₄=1, and A represents a score normalization value, B represents a favorable rate, C represents a like rate, and D represents a normalization value of a number of shares. Wherein, λ₁, λ₂, λ₃, and λ₄ are determined according to degree of importance of corresponding items to the recommendation score. The first sorting acquiring unit 603 is for acquiring a preset number of call records from the recommended call records as the call records to be recommended according to an order of the recommendation scores from high to low. Wherein, the call record includes a call recording.

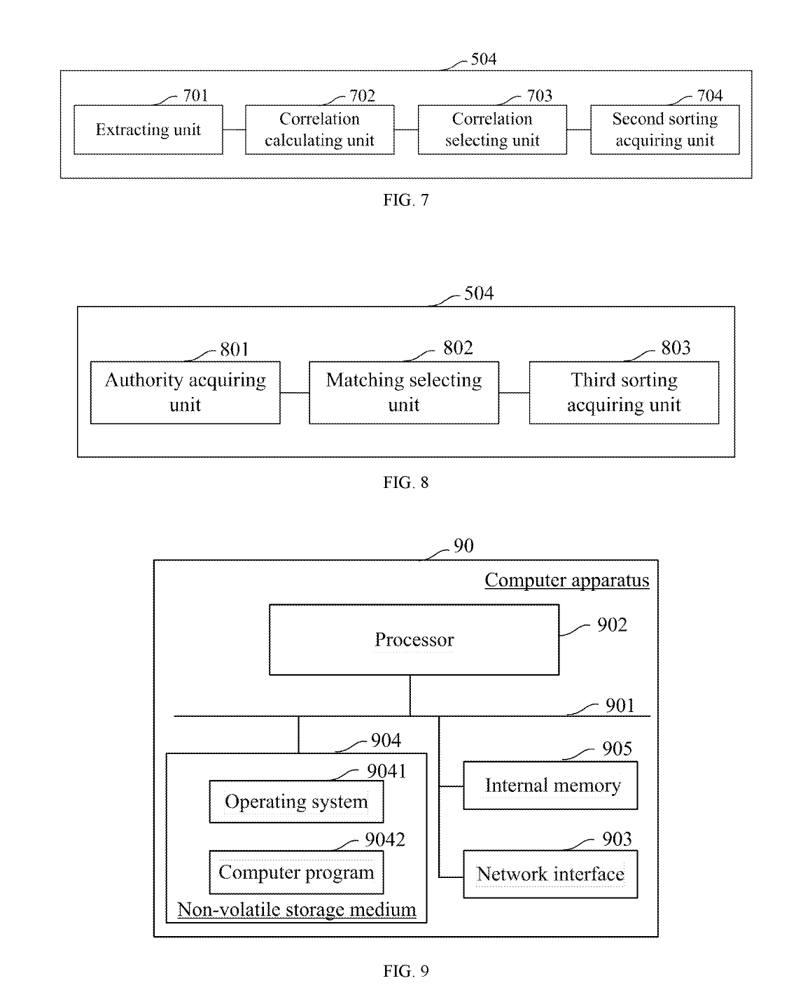

FIG. 7 is a schematic block diagram of the second selecting unit 504 provided by an embodiment of the present disclosure. The second selecting unit is for selecting corresponding call records from the call records satisfying the preset condition as call records to be recommended according to a second preset rule. As shown in FIG. 7, the second selecting unit 504 includes an extracting unit 701, a correlation calculating unit 702, a correlation selecting unit 703, and a second sorting acquiring unit 704.

The extracting unit 701 is for extracting a characteristic of a call record historically viewed by the current user. The correlation calculating unit 702 is for calculating a correlation between the characteristic and characteristic of the call record satisfying the preset condition. The correlation selecting unit 703 is for selecting call recordings corresponding to the correlation greater than a correlation threshold. The second sorting acquiring unit 704 is for sorting the selected call records according to a preset ordering rule, and acquiring a preset number of call records from the sorted call records as the call records to be recommended. The preset ordering rule includes: for different products, according to the order of the correlations from large to small, the order of the sales amount from high to low, the order of the time of call from lately to early, the order of the total numbers of times of calls from less to more.

FIG. 8 is a schematic block diagram of the second selecting unit 504 provided by another embodiment of the present disclosure. The second selecting unit is for selecting corresponding call recordings from the call recordings satisfying the preset condition as call recordings to be recommended according to a second preset rule. The second selecting unit 504 includes an authority acquiring unit 801, a matching selecting unit 802, and a third sorting acquiring unit 803.

The authority acquiring unit 801 is for acquiring an authority of the current user. The matching selecting unit 802 is for selecting call records that match with the authority of the current user from the call records satisfying the preset condition. The third sorting acquiring unit 803 is for sorting the selected call records according to a preset ordering rule, and taking the sorted call records as the call records to be recommended. The preset ordering rule may be: according to the order of the sales amount from high to low, the order of the time of call from lately to early, the order of the total numbers of times of calls from less to more.

In other embodiments, it could be understood that, when the call records to be recommended obtained by the user obtain are numerous, the user could further screen the call records that the user is interested according to the user's own demand. Specifically, the recording recommendation device further includes an instruction acquiring unit and a screening displaying unit. The instruction acquiring unit is for acquiring a screening instruction of the current user, and the screening displaying unit is for acquiring call records related to the screening instruction of the current user to display from the displayed call records.

For the specific working process of the device and the unit described above, reference may be made to the corresponding process in the foregoing embodiments of method, and the beneficial effects achieved may also be referred to the beneficial effects achieved in the foregoing embodiments of method, and details are not described herein again.

The above recording recommendation device could be implemented in the form of a computer program, and the computer program could be run on a computer apparatus as shown in FIG. 9.

FIG. 9 is a schematic block diagram of a computer apparatus provided by an embodiment of the present disclosure. The computer apparatus 90 could be a terminal. The apparatus 90 includes a processor 902, a memory, and a network interface 903 which are connected by a system bus 901, wherein, the memory could include a non-volatile storage medium 904 and an internal memory 905.

The non-volatile storage medium 904 could store an operating system 9041 and a computer program 9042. When the computer program 9042 is executed, the processor 902 could be caused to perform a recording recommendation method.

The processor 902 is used to provide computing and control capabilities, to support the operation of the entire apparatus 90.

The internal memory 905 provides an environment for the operation of the computer program in the non-volatile storage medium, and when the computer program is executed by the processor 902, the processor 902 could be caused to perform a recording recommendation method.

The network interface 903 is used for network communication, such as receiving instructions and the like. A person skilled in the art could understand that, the structure shown in FIG. 9 is only a block diagram of a part of the structure related to the solution of the present disclosure, and does not constitute a limitation to the apparatus 90 to which the solution of the present disclosure is applied. The specific apparatus 90 may include more or fewer components than those shown in the figure, or combine some components, or have a different arrangement for the components.

Wherein, the processor 902 is for running a computer program stored in the memory, to implement the following steps: determining whether a current user is a new user, if an instruction of the current user to view sales call recordings is received; selecting corresponding call records from sales call recording records as call records to be recommended according to a first preset rule if the current user is a new user, wherein, the call record includes a call recording; acquiring call records satisfying a preset condition from the sales call recording records if the current user is not a new user; selecting corresponding call records from the call records satisfying the preset condition as call records to be recommended according to a second preset rule; displaying the call records to be recommended to the current user.

In an embodiment, when the processor 902 performs acquiring corresponding call records from sales call recording records as call records to be recommended according to a first preset rule, the processor 902 specifically performs the following steps: acquiring scores, comments, numbers of likes, and numbers of shares of call recordings corresponding to recommended call records from the sales call recording records; calculating recommendation scores of the call recordings according to a preset formula, wherein, the preset formula is: M=λ₁A+λ₂B+λ₃C+λ₄D, wherein, M is the recommendation score, and λ₁, λ₂, λ₃, and λ₄ are weight coefficients, and λ₁+λ₂+λ₃+λ₄=1, and A represents a score normalization value, B represents a favorable rate, C represents a like rate, and D represents a normalization value of a number of shares; acquiring a preset number of call records from the recommended call records as the call records to be recommended according to an order of the recommendation scores of corresponding call recordings from high to low.

In an embodiment, when the processor 902 performs selecting corresponding call records from the call records satisfying the preset condition as call records to be recommended according to a second preset rule, the processor 902 specifically performs the following steps:

extracting a characteristic of a call record historically viewed by the current user; calculating a correlation between the characteristic and characteristic of the call record satisfying the preset condition; selecting call records corresponding to the correlation greater than a correlation threshold; sorting the selected call records according to a preset ordering rule, and acquiring a preset number of call records from the sorted call records as the call records to be recommended.

In an embodiment, when the processor 902 performs selecting corresponding call records from the call records satisfying the preset condition as call records to be recommended according to a second preset rule, the processor 902 specifically performs the following steps: acquiring an authority of the current user; selecting call records that match with the authority of the current user from the call records satisfying the preset condition; sorting the selected call records according to a preset ordering rule, and acquiring a preset number of call records from the sorted call records as the call records to be recommended.

In an embodiment, the processor 902 further performs the following steps: acquiring a screening instruction of the current user; acquiring call records related to the screening instruction of the current user to display from the displayed call records.

The embodiment of the present disclosure further provides a computer-readable storage medium, and the computer-readable storage medium stores a computer program, and the computer program includes program instructions, and when being executed by a processor, the program instructions implement the following steps: determining whether a current user is a new user, if an instruction of the current user to view sales call recordings is received; selecting corresponding call records from sales call recording records as call records to be recommended according to a first preset rule if the current user is a new user, wherein, the call record includes a call recording; acquiring call records satisfying a preset condition from the sales call recording records if the current user is not a new user; selecting corresponding call records from the call records satisfying the preset condition as call records to be recommended according to a second preset rule; displaying the call records to be recommended to the current user.

In an embodiment, when the program instructions are executed by the processor for acquiring corresponding call records from sales call recording records as call records to be recommended according to a first preset rule, the program instructions specifically implement: acquiring scores, comments, numbers of likes, and numbers of shares of call recordings corresponding to recommended call records from the sales call recording records; calculating recommendation scores of the call recordings according to a preset formula, wherein, the preset formula is: M=λ₁A+λ₂B+λ₃C+λ₄D, wherein, M is the recommendation score, and λ₁, λ₂, λ₃, and λ₄ are weight coefficients, and λ₁+λ₂+λ₃+λ₄=1, and A represents a score normalization value, B represents a favorable rate, C represents a like rate, and D represents a normalization value of a number of shares; acquiring a preset number of call records from the recommended call records as the call records to be recommended according to an order of the recommendation scores of corresponding call recordings from high to low.

In an embodiment, when the program instructions are executed by the processor for selecting corresponding call records from the call records satisfying the preset condition as call records to be recommended according to a second preset rule, the program instructions specifically implement: extracting a characteristic of a call record historically viewed by the current user; calculating a correlation between the characteristic and characteristic of the call record satisfying the preset condition; selecting call records corresponding to the correlation greater than a correlation threshold; sorting the selected call records according to a preset ordering rule, and acquiring a preset number of call records from the sorted call records as the call records to be recommended.

In an embodiment, when the program instructions are executed by the processor for selecting corresponding call records from the call records satisfying the preset condition as call records to be recommended according to a second preset rule, the program instructions specifically implement: acquiring an authority of the current user; selecting call records that match with the authority of the current user from the call records satisfying the preset condition; sorting the selected call records according to a preset ordering rule, and acquiring a preset number of call records from the sorted call records as the call records to be recommended.

In an embodiment, when the program instructions are executed by the processor, the program instructions specifically implement: acquiring a screening instruction of the current user; acquiring call records related to the screening instruction of the current user to display from the displayed call records.

A person skilled in the art could clearly understand that, for the convenience and brevity of the description, the specific working process of the apparatus, the device and the unit described above could refer to the corresponding process in the foregoing embodiments of the method, and details are not described herein again. The above description is only the specific embodiment of the present disclosure, but the scope of the present disclosure is not limited thereto, and any person skilled in the art could easily conceive various equivalent modifications or alternatives within the technical scope disclosed by the present disclosure, and these modifications or alternatives should all fall into the protection scope of the present disclosure.

1. A recording recommendation method, comprising:
determining whether a current user is a new user, if an instruction of the current user to view sales call recordings is received;
selecting corresponding call records from sales call recording records as call records to be recommended according to a first preset rule, if the current user is a new user, wherein, the call record comprises a call recording;
acquiring call records satisfying a preset condition from the sales call recording records, if the current user is not a new user;
selecting corresponding call records from the call records satisfying the preset condition as call records to be recommended according to a second preset rule;
displaying the call records to be recommended to the current user.

2. The method according to claim 1, wherein, the step of selecting corresponding call records from sales call recording records as call records to be recommended according to a first preset rule, comprises:
acquiring scores, comments, numbers of likes, and numbers of shares of call recordings corresponding to recommended call records from the sales call recording records;
calculating recommendation scores of the call recordings according to a preset formula, wherein, the preset formula is: M=λ₁A+λ₂B+λ₃C+λ₄D, wherein, M is the recommendation score, and λ₁, λ₂, λ₃, and λ₄ are weight coefficients, and λ₁+λ₂+λ₃+λ₄=1, and A represents a score normalization value, B represents a favorable rate, C represents a like rate, and D represents a normalization value of the number of shares;
acquiring a preset number of call records from the recommended call records as the call records to be recommended according to an order of the recommendation scores of corresponding call recordings from high to low.

3. The method according to claim 1, wherein, the step of selecting corresponding call records from the call records satisfying the preset condition as call records to be recommended according to a second preset rule, comprises:
extracting a characteristic of a call record historically viewed by the current user;
calculating a correlation between the characteristic and characteristic of the call record satisfying the preset condition;
selecting call records corresponding to the correlation greater than a correlation threshold;
sorting the selected call records according to a preset ordering rule, and acquiring a preset number of call records from the sorted call records as the call records to be recommended.

4. The method according to claim 1, wherein, the step of selecting corresponding call records from the call records satisfying the preset condition as call records to be recommended according to a second preset rule, comprises:
acquiring an authority of the current user;
selecting call records that match with the authority of the current user from the call records satisfying the preset condition;
sorting the selected call records according to a preset ordering rule, and acquiring a preset number of call records from the sorted call records as the call records to be recommended.

5. The method according to claim 1, wherein, the method further comprises:
acquiring a screening instruction of the current user;
acquiring call records related to the screening instruction of the current user to display from the displayed call records.

6. (canceled)

7. (canceled)

8. (canceled)

9. (canceled)

10. (canceled)

11. A computer apparatus, comprising: a memory, and a processor connected to the memory;
wherein the memory is used for storing computer program for implementing recording recommendation; and the processor is used for running the computer program stored in the memory, to perform the following steps:
determining whether a current user is a new user, if an instruction of the current user to view sales call recordings is received;
selecting corresponding call records from sales call recording records as call records to be recommended according to a first preset rule, if the current user is a new user,
wherein, the call record comprises a call recording;
acquiring call records satisfying a preset condition from the sales call recording records, if the current user is not a new user;
selecting corresponding call records from the call records satisfying the preset condition as call records to be recommended according to a second preset rule;
displaying the call records to be recommended to the current user.

12. The computer apparatus according to claim 11, wherein, when the processor performs the step of selecting corresponding call records from sales call recording records as call records to be recommended according to a first preset rule, the processor specifically implements:
acquiring scores, comments, numbers of likes, and numbers of shares of call recordings corresponding to recommended call records from the sales call recording records;
calculating recommendation scores of the call recordings according to a preset formula, wherein, the preset formula is: M=λ₁A+λ₂B+λ₃C+λ₄D, wherein, M is the recommendation score, and λ₁, λ₂, λ₃, and λ₄ are weight coefficients, and λ₁+λ₂+λ₃+λ₄=1, and A represents a score normalization value, B represents a favorable rate, C represents a like rate, and D represents a normalization value of the number of shares;
acquiring a preset number of call records from the recommended call records as the call records to be recommended according to an order of the recommendation scores of corresponding call recordings from high to low.

13. The computer apparatus according to claim 11, wherein, when the processor performs the step of selecting corresponding call records from the call records satisfying the preset condition as call records to be recommended according to a second preset rule, the processor specifically implements:
extracting a characteristic of a call record historically viewed by the current user;
calculating a correlation between the characteristic and characteristic of the call record satisfying the preset condition;
selecting call records corresponding to the correlation greater than a correlation threshold;
sorting the selected call records according to a preset ordering rule, and acquiring a preset number of call records from the sorted call records as the call records to be recommended.

14. The computer apparatus according to claim 11, wherein, when the processor performs the step of selecting corresponding call records from the call recording records satisfying the preset condition as call records to be recommended according to a second preset rule, the processor specifically implements:
acquiring an authority of the current user;
selecting call records that match with the authority of the current user from the call records satisfying the preset condition;
sorting the selected call records according to a preset ordering rule, and acquiring a preset number of call records from the sorted call records as the call records to be recommended.

15. The computer apparatus according to claim 11, wherein, the processor further performs the following steps:
acquiring a screening instruction of the current user;
acquiring call records related to the screening instruction of the current user to display from the displayed call records.

16. A computer-readable storage medium, wherein, the computer-readable storage medium stores computer program, and the computer program comprises program instructions, and when the program instructions are executed by a processor,
the program instructions implement the following steps:
determining whether a current user is a new user, if an instruction of the current user to view sales call recordings is received;
selecting corresponding call records from sales call recording records as call records to be recommended according to a first preset rule, if the current user is a new user,
wherein, the call record comprises a call recording;
acquiring call records satisfying a preset condition from the sales call recording records, if the current user is not a new user;
selecting corresponding call records from the call records satisfying the preset condition as call records to be recommended according to a second preset rule;
displaying the call records to be recommended to the current user.

17. The computer-readable storage medium according to claim 16, wherein,
when the program instructions are executed by the processor for selecting corresponding call records from sales call recording records as call records to be recommended according to a first preset rule, the program instructions specifically implement:
acquiring scores, comments, numbers of likes, and numbers of shares of call recordings corresponding to recommended call records from the sales call recording records;
calculating recommendation scores of the call recordings according to a preset formula, wherein, the preset formula is: M=λ₁A+λ₂B+λ₃C+λ₄D, wherein, M is the recommendation score, and λ₁, λ₂, λ₃, and λ₄ are weight coefficients, and λ₁+λ₂+λ₃+λ₄=1, and A represents a score normalization value, B represents a favorable rate, C represents a like rate, and D represents a normalization value of the number of shares;
acquiring a preset number of call records from the recommended call records as the call records to be recommended according to an order of the recommendation scores of corresponding call recordings from high to low.

18. The computer-readable storage medium according to claim 16,
wherein, when the program instructions are executed by the processor for selecting corresponding call records from the call records satisfying the preset condition as call records to be recommended according to a second preset rule,
the program instructions specifically implement:
extracting a characteristic of a call record historically viewed by the current user;
calculating a correlation between the characteristic and characteristic of the call record satisfying the preset condition;
selecting call records corresponding to the correlation greater than a correlation threshold;
sorting the selected call records according to a preset ordering rule, and acquiring a preset number of call records from the sorted call records as the call records to be recommended.

19. The computer-readable storage medium according to claim 16,
wherein, when the program instructions are executed by the processor for selecting corresponding call records from the call records satisfying the preset condition as call records to be recommended according to a second preset rule,
the program instructions specifically implement:
acquiring an authority of the current user;
selecting call records that match with the authority of the current user from the call records satisfying the preset condition;
sorting the selected call records according to a preset ordering rule, and acquiring a preset number of call records from the sorted call records as the call records to be recommended.

20. The computer-readable storage medium according to claim 16, wherein the steps further comprise:
acquiring a screening instruction of the current user;
acquiring call records related to the screening instruction of the current user to display from the displayed call records.
